(19) United States
(12) Patent Application Publication
(10) Pub. No.: US 2021/0068547 A1
(43) Pub. Date: Mar. 11, 2021

(54) Toolless Assembly Method for Upholstered Furniture

(71) Applicant: Overman International Corporation, Dandridge, TN (US)

(72) Inventors: Trevor Hodgson, Dandridge, TN (US); Gary Slone, Dandridge, TN (US)

(73) Assignee: Overman International Corporation, Dandridge, TN (US)

(21) Appl. No.: 17/012,343

(22) Filed: Sep. 4, 2020

Related U.S. Application Data
(60) Provisional application No. 62/896,792, filed on Sep. 6, 2019.

(51) Int. Cl. A47C 4/02; F16B 12/20

(52) U.S. Cl. CPC A47C 4/021; F16B 12/20; A47C 4/028

(57) ABSTRACT

A toolless assembly method for assembling structures having multiple component pieces, including the step of providing a plurality of component pieces, the pieces having cooperating brackets and receivers for slidingly receiving the brackets and rotating latches. In another step, the component pieces are assembled by orienting the components into a desired configuration corresponding to the assembled structure, with adjacent brackets installed into adjacent receivers. In a further step, the component pieces are locked together by rotating the latches so that the latches bear against adjoining component pieces to lock the adjacent component pieces together.

### FIELD

The present disclosure relates to furniture and methods for manufacturing furniture components and methods for assembling the components. More particularly, the disclosure relates to toolless furniture and to a toolless assembly method for upholstered furniture.

### BACKGROUND

Improvement is desired in the provision of goods having multiple components that are shipped to consumers and assembled by the consumer. In particular, improvement is desired in the provision of furniture that has multiple component parts that are compactly nested in a box for shipment to a consumer and then assembled by the consumer.

What is desired is goods that can be assembled from components that may be compactly nested in a box for shipment, and then easily assembled into the good by the end user without the use of tools. In particular, this is desired for goods such as upholstered furniture.

### SUMMARY

The disclosure provides a toolless assembly method for assembling furniture having multiple component pieces; and toolless furniture.

In one aspect, the method includes the step of providing a furniture back, a furniture seat, and a pair of furniture arms, cooperating brackets located on the furniture back, the furniture seat, each of the furniture arms, the brackets being locatable to be alignable and configured to slidingly nest together, and a rotatable latch located on each of the furniture arms.

In an assembly step, the furniture back is assembled onto the furniture seat and the furniture arms are assembled onto the furniture seat and the furniture back without the use of any tools. This is accomplished by aligning each of the brackets with a corresponding one of the brackets and slidingly nesting the brackets so that the furniture back is assembled onto the furniture seat and the furniture arms are assembled onto the furniture seat and the furniture back. The latches are manually rotated to latch each of the furniture arms to the furniture seat.

In another aspect, the disclosure relates to assembled furniture having multiple component pieces assembled without tools. The furniture includes a furniture back, a furniture seat, and a pair of furniture arms. Cooperating brackets are located on the furniture back, the furniture seat, and each of the furniture arms. The brackets are slidingly nested together. A latch is located on each of the furniture arms latching each of the furniture arms to the furniture seat.

In a further aspect, toolless furniture according to the disclosure includes a furniture back, a furniture seat, and a pair of furniture arms. Cooperating brackets are located on the furniture back, the furniture seat, and each of the furniture arms. The brackets are configured to be alignable and slidingly nestable together. A rotatable latch is located on each of the furniture arms and is manually rotatable to latch each of the furniture arms to the furniture seat.

The furniture is assembled by assembling the furniture arms onto the furniture seat and the furniture back without the use of any tools by aligning each of the brackets with a corresponding one of the brackets and slidingly nesting the brackets so that the furniture back is assembled onto the furniture seat and the furniture arms are assembled onto the furniture seat and the furniture back. The latch is manually rotated to latch each of the furniture arms to the furniture seat.

### BRIEF DESCRIPTION OF THE DRAWINGS

Further advantages of the disclosure are apparent by reference to the detailed description when considered in conjunction with the figures, which are not to scale so as to more clearly show the details, wherein like reference numbers indicate like elements throughout the several views, and wherein:

FIG. 1A shows an assembled upholstered chair according to the disclosure.

FIG. 1B shows components and steps in their assembly in providing the chair of FIG. 1A.

FIGS. 2A-2C show installation of a chair seat onto a chair back

FIGS. 3A-3C show the chair seat as installed on the chair back.

FIGS. 4A-4C show installation of chair arms onto opposite sides of the chair back and the chair seat.

FIGS. 5A-5C show the assembled chair and depict rotation of swing latches to lock the chair components in place.

### DETAILED DESCRIPTION

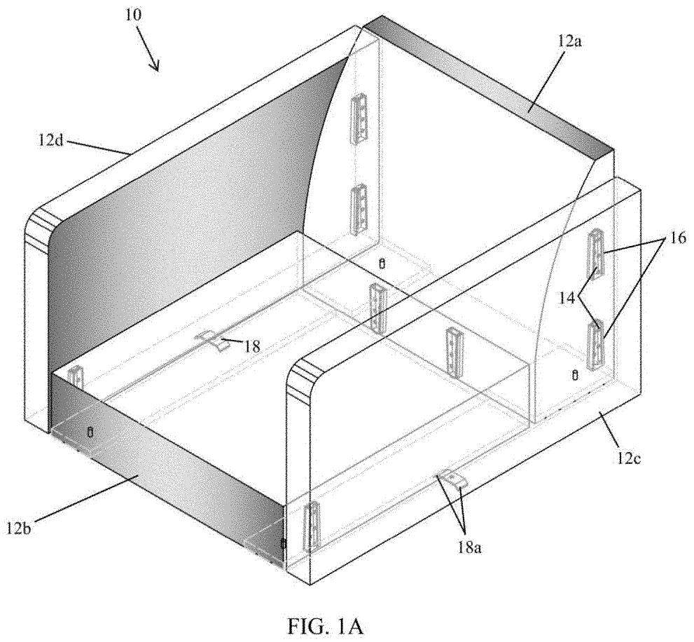

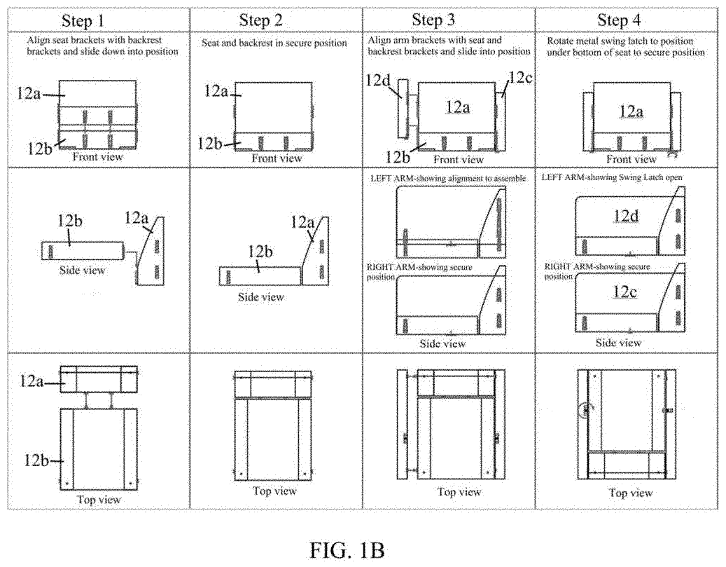

With initial reference to FIG. 1A, there is shown an assembled upholstered chair 10 according to the disclosure. The design of the chair 10 enables ease of assembly by the end consumer. While the structure of a chair is described, the furniture may be configured to provide a wide variety of furniture structures, including chairs, sofas, loveseats, and the like.

The chair is made of components 12a-12d which may be easily assembled into the chair 10 without the use of tools, such as screwdrivers, wrenches and the like. The components 12a-12d of the chair 10 are configured to be compactly nested in a box for shipment to an end user consumer. The components 12a-12d are configured so as to be easily assembled into the chair 10 by the consumer without the use of any tools. In this regard, the components 12a-12d are configured to attached to one another by an end user by matingly engaging brackets 14 with receivers 16, and rotating swing latches 18 into position, with no tools required for this assembly. The brackets 14, the receivers 16, and the swing latches 18 are pre-installed on desired ones of the components 12a-12d at the manufacturing facility during manufacture of the components 12a-12d.

While the terms brackets and receivers are used herein for explanation, it will be appreciated that the brackets 14 and the receivers 16 are both bracket structures, to provide cooperating brackets configured to slidingly nest together. As explained below, the brackets 14 and the receivers 16 are each swedge-shaped and have a reducing taper along their length. The brackets 14 are slightly smaller in dimension to slidingly seat into and nest into the receivers 16. This nesting relationship is accomplished by sliding the bracket 14 into the receiver 16 or by sliding the receiver 16 over the bracket 14.

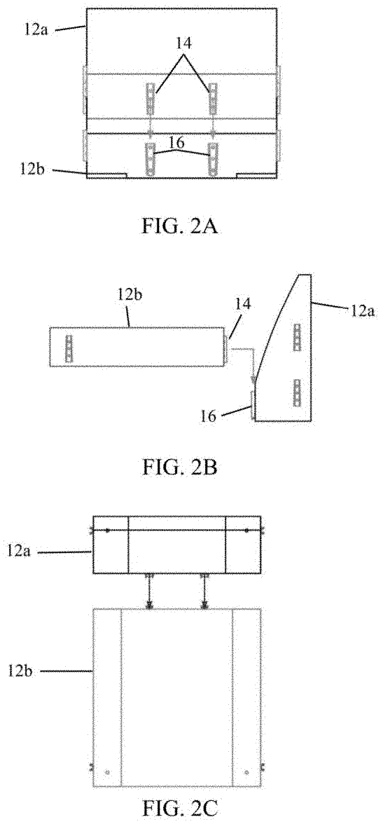

FIG. 1B shows the components 12a-12d and steps in their assembly in providing the chair of FIG. 1A. These steps are shown in larger print in the remaining FIGS. 2A-5C and discussed below.

The component 12a is a chair back. The component 12b is a chair seat. The components 12c and 12d are chair arms. The components 12a-12d are upholstered and include rigid frame portions and upholstery located so that the assembled components provide the upholstered chair 10. Each of the components 12a-12d has rigid frame portions made of wood or plastic or other suitable furniture frame material. A fabric or other decorative sheet upholstery is secured to edges of the frame portions as by fasteners. Furniture padding, such as foam or other conventional furniture padding preferably underlies the upholstery for comfort and the like. For example, the chair seat 12b has rigid frame portions 12bb connected together to provide a rigid frame, the exterior of which is covered by upholstery 12bbb.

The brackets 14, the receivers 16, and the swing latches 18 are mounted on the rigid frame portions as by fasteners and located so as to be hidden from view upon completion of assembly of the chair 10. It will be appreciated that other furniture according to the disclosure, such as sofas, loveseats, and the like, would similarly have a back, a seat, and arms. As shown, the swing latches are located on lower surfaces of the chair arms 12c and 12d, and located to latch between the chair seat 12b and the chair arms 12c and 12d. It will be appreciated that the swing latches 18 may be located to latch between any of the components 12a-12d.

As shown in FIGS. 2A-2C, 3A-3C, 4A-4C, and 5A-5C, the brackets 14 and the receivers are configured to be slidingly engaged with the brackets 14 received by the receivers 16. Both the brackets 14 and the receivers 16 are swedge-shaped and have a reducing taper along their length. That is, both are generally in the shape of a V, with the brackets 14 being slightly smaller in dimension to slidingly seat into and nest into the receivers 16. This nesting relationship is accomplished by sliding the bracket 14 into the receiver 16 or by sliding the receiver 16 over the bracket 14. This provides a secure interference fit to secure the components 12a-12d together. Once the components 12a-12d are assembled together in a desired manner to provide the chair 10, the rotating swing latches 18 may be manually rotated to position them to latch adjacent ones of the components together to further lock the components together and further rigidify the chair 10.

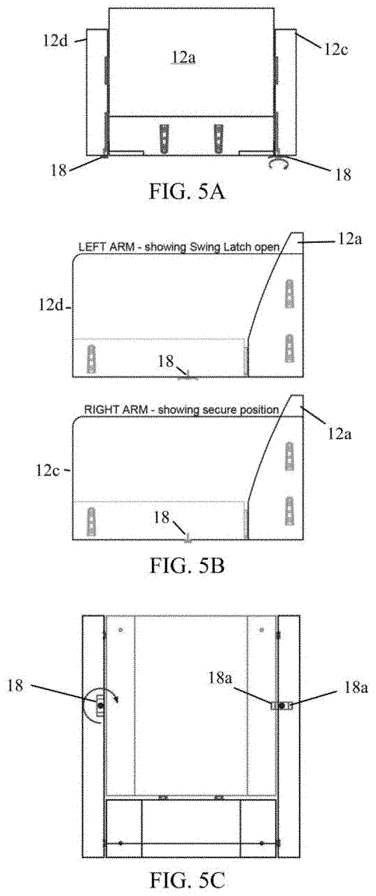

The rotating swing latches 18 may be located on edges of the frame portions of the components 12a-12d so as to be closely adjacent an adjacent a frame portion of an adjoining one of the components 12a-12d. The latches 18 are generally rectangular in shape with a depending short leg 18a at each end configured to bear against the frame portions. The latches 18 are rotatably mounted to one of the frame portions by a fastener extending through a central aperture of the latch 18. Then, once the components 12a-12d are assembled together, the latches 18 are rotated so that the legs 18a of the latches 18 bear against the adjoining frame portions of the adjoining components and serve to lock the adjacent components together (FIGS. 5A-5C).

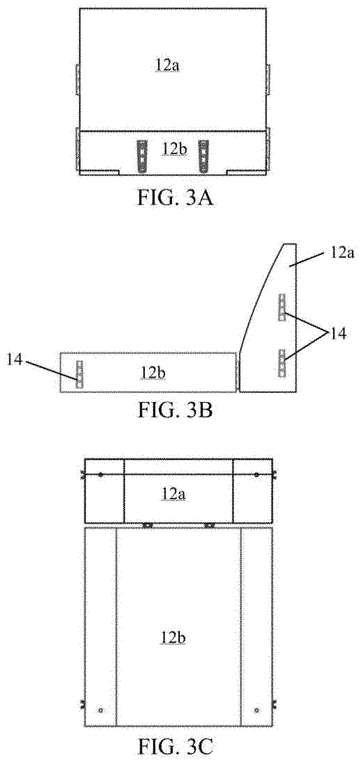

FIGS. 2A-2C show a first assembly step according to the disclosure. In this step, the chair seat 12b is installed on the chair back 12a by lifting the chair seat 12b, positioning it in its desired location relative to the chair back 12a so that brackets 14 of the seat 12b are aligned with receivers 16 of the chair back 12a, and sliding such brackets 14 of the chair seat 12b into correspondingly located receivers 16 of the chair back 12a so that the chair seat 12b is oriented onto the chair back 12a in a desired orientation. FIGS. 3A-3C show successful completion of this step. As will be noted, no tools are required for this assembly.

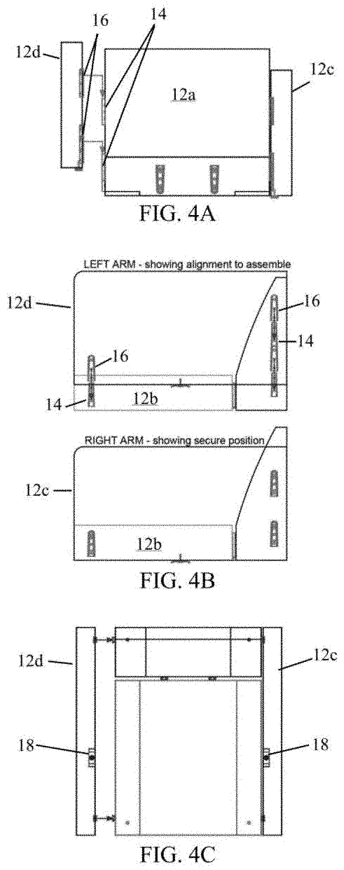

FIGS. 4A-4C show a next assembly step according to the disclosure. In this step, the chair arms 12c and 12d are each individually installed onto opposite sides of the chair back 12a and the chair seat 12b. This is accomplished in a similar manner, as by lifting the chair arms 12c and 12d and sliding receivers 16 thereof over brackets 14 of the chair back 12a and the chair seat 12b so that the chair arms 12c and 12d are oriented onto the chair back 12a and the chair seat 12b in a desired orientation. FIGS. 5A-5C shows successful completion of this step.

In addition, FIGS. 5A-5C also show the swing latches 18 being rotated (see arrow) so that the legs 18a of the latches 18 bear against the adjoining frame portions of the adjoining components 12a-12d and serve to lock the adjacent components together. As will be noted, no tools are required for this assembly.

Accordingly, it will be appreciated that the present disclosure advantageously provides goods that can be assembled from components that may be compactly nested in a box for shipment, and then easily assembled into the good by the end user without the use of tools. In particular, the disclosure provides such structures and methods for providing upholstered furniture that can be assembled without the use of tools.

The foregoing description of preferred embodiments for this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated.

1. A toolless assembly method for assembling furniture having multiple component pieces, comprising the steps of:
providing a furniture back, a furniture seat, and a pair of furniture arms, cooperating brackets located on the furniture back, the furniture seat, each of the furniture arms, the brackets being locatable to be alignable and configured to slidingly nest together, and a rotatable latch located on each of the furniture arms;
assembling the furniture back onto the furniture seat and assembling the furniture arms onto the furniture seat and the furniture back without the use of any tools by aligning each of the brackets with a corresponding one of the brackets and slidingly nesting the brackets so that the furniture back is assembled onto the furniture seat and the furniture arms are assembled onto the furniture seat and the furniture back; and
manually rotating the latches to latch each of the furniture arms to the furniture seat.

2. The method of claim 1, wherein the furniture comprises a chair.

3. The method of claim 1, wherein each of the furniture back, furniture seat, and furniture arms is upholstered.

4. The method of claim 1, wherein each of the brackets is swedge-shaped and elongate and has a reducing taper its length.

5. Assembled furniture having multiple component pieces assembled without tools, comprising: a furniture back, a furniture seat, and a pair of furniture arms, cooperating brackets located on the furniture back, the furniture seat, each of the furniture arms, the brackets slidingly nested together, and a latch located on each of the furniture arms latching each of the furniture arms to the furniture seat.

6. The furniture of claim 5, wherein the furniture comprises a chair.

7. The furniture of claim 5, wherein each of the furniture back, furniture seat, and furniture arms is upholstered.

8. The furniture of claim 5, wherein each of the brackets is swedge-shaped and elongate and has a reducing taper its length.

9. Assembled furniture having multiple component pieces assembled without tools, comprising: a furniture back, a furniture seat, and a pair of furniture arms, cooperating brackets located on the furniture back, the furniture seat, each of the furniture arms, the brackets configured to be alignable and slidingly nestable together, and a rotatable latch located on each of the furniture arms and manually rotatable to latch each of the furniture arms to the furniture seat.
wherein the furniture is assembled by assembling the furniture arms onto the furniture seat and the furniture back without the use of any tools by aligning each of the brackets with a corresponding one of the brackets and slidingly nesting the brackets so that the furniture back is assembled onto the furniture seat and the furniture arms are assembled onto the furniture seat and the furniture back, manually rotating the latches to latch each of the furniture arms to the furniture seat.

10. The furniture of claim 9, wherein the furniture comprises a chair.

11. The furniture of claim 9, wherein each of the furniture back, furniture seat, and furniture arms is upholstered.

12. The furniture of claim 9, wherein each of the brackets is swedge-shaped and elongate and has a reducing taper its length.
